(19) United States
(12) Patent Application Publication
(10) Pub. No.: US 2026/0021495 A1
(43) Pub. Date: Jan. 22, 2026

(54) CENTRIFUGAL SEPARATOR FOR SEPARATING LIQUID FROM A WET GAS

(71) Applicant: FREEVALVE AB, Ängelholm (SE)

(72) Inventor: Andreas MÖLLER, Glumslöv (SE)

(21) Appl. No.: 18/993,041

(22) PCT Filed: Jul. 4, 2023
(86) PCT No.: PCT/SE2023/050694

§ 371 Date: Jan. 10, 2025

(30) Foreign Application Priority Data
Jul. 11, 2022 (SE) 2250883-2

(51) Int. Cl. B04C 3/06; B04C 3/00

(52) U.S. Cl. CPC B04C 3/06; B04C 2003/003

(57) ABSTRACT

The invention relates to a centrifugal separator (1) for separating liquid from a wet gas. The separator (1) comprises an inlet opening for wet gas and an outer housing (2) having a liquid outlet opening (4) and a gas outlet opening (5). The centrifugal separator is characterized in further comprising an annular inner housing (3) located within the outer housing (2) and having an inlet orifice (10) of the inlet opening of the centrifugal separator (1). a lower liquid outlet opening (11) and an annular upper rim (12), wherein an inner surface of a top section (9) of the outer housing (2) and the upper rim (12) of the inner housing (3) being located adjacent each other and together defining an upper liquid outlet opening (17) of the inner housing (3), wherein the gas outlet opening (5) of the outer housing (2) is located radially inside the upper rim (12) if the inner housing. and wherein the upper liquid outlet opening (17) of the inner housing (3) is connected to the liquid outlet opening (4) of the outer housing (2).

### TECHNICAL FIELD OF THE INVENTION

The present invention relates in general to a pressure fluid handling system configured for separating a liquid from a wet gas, i.e. a fluid separator, wherein the separation of the fluids is based on the centrifugal principles.

The present invention relates in particular to a centrifugal separator for separating liquid from a wet gas, wherein the separator comprises an outer housing. The outer housing comprises a liquid outlet opening located at a bottom of the outer housing, a gas outlet opening located at a top of the outer housing, and wherein the centrifugal separator comprises an inlet opening for wet gas, located between the liquid outlet opening and the gas outlet opening of the outer housing.

Such centrifugal separator is especially useful in combination with combustion engine assemblies and pneumatic machines/tools having pneumatically driven devices/components, and especially when the wet gas is pressurized.

### BACKGROUND OF THE INVENTION

The present invention is based on the fact that many known applications in various technical fields make use of a pressure fluid (gas, including pressurized gas) in a pressure fluid circuit in order to operate/drive a pneumatic device or an equipment to perform useful duty. Thus, many applications/devices in various technical fields make use of internal elements/components that are in motion during operation of the device, wherein the application/device uses gas, including pressurized gas, for/in the operation thereof. Such applications/devices usually experience that the lubrication liquid will become mixed with the pressure fluid (gas having elevated pressure). The mixing may be intentional in order to transport lubrication liquid by means of the pressure fluid (gas) to the moving internal elements, to provide cooling to the device or components of the assembly, etc. by controlled leakage at different seals or injection of the lubrication liquid into the gas circuit. In other situations, the mixing of the gas and the liquid is unintentional.

In some applications the pressure fluid (gas) is circulated/reused, i.e. a so-called closed pressure fluid circuit, and in some applications the gas, including pressurized gas, is released/ventilated after use. In both situations, and independently whether the mixing is intentional and/or unintentional, it is often required to separate the excess fluid from the gas, during the recirculation or before the gas is discharged. Too high liquid content in the gas in an application having a closed pressure fluid circuit will have negative effect on the operation of the device, and too high liquid content in discharged gas will have negative effect on the work environment and/or nature. Especially when the gas is pressurized since the liquid unlike gas is incompressible.

For instance, such centrifugal separator is of great value for combustion engines and pneumatic machines/tools having pneumatic devices/components that makes use of the pressure fluid in a closed pressure fluid circuit and a pressure difference over the pneumatic device in order to operate/drive the pneumatic device, e.g. moving an element back and forth or rotating an element.

The inventor has not found any known fluid separator capable of separating a liquid from a pressurized gas with high separation capacity over a wide range of flow speed of the gas through the separator and/or over a wide range of pressure level of the gas. Some known applications may provide high separation capacity for a fixed/predetermined flow speed of the gas, and/or a fixed/predetermined pressure level of the gas.

### OBJECT OF THE INVENTION

The aim of the present invention is to set aside the drawbacks and shortcomings of the previously known centrifugal separators and to provide an improved centrifugal separator. A primary object of the present invention is to provide an improved centrifugal separator of the initially defined type wherein the separation capacity is high over a wide range of flow speed of the gas through the separator. It is another object of the present invention to provide a centrifugal separator, wherein the separation capacity is high over a wide range of pressure levels of the gas. It is another object of the present invention to provide a centrifugal separator, which has no moving parts/elements. It is another object of the present invention to provide a centrifugal separator, which is capable of receiving a variable flow speed of the gas and/or a variable pressure level of the gas. It is another object of the invention of the present invention to provide a centrifugal separator, wherein the liquid separated in the inner housing is not reentered into the flow of gas.

### SUMMARY OF THE INVENTION

According to the invention at least the primary object is attained by means of the initially defined centrifugal separator having the features defined in the independent claim. Preferred embodiments of the present invention are further defined in the dependent claims.

According to the present invention, there is provided a centrifugal separator of the initially defined type, which is characterized in further comprising:
an annular inner housing located within the outer housing forming an intermediate volume delimited by the inner housing and the outer housing, wherein the inlet opening of the centrifugal separator extends to the inner housing and the inner housing comprises:
   an inlet orifice of the inlet opening,
   a lower liquid outlet opening, located at a bottom of the inner housing, and
   an annular upper rim,
wherein an inner surface of a top section of the outer housing and the upper rim of the inner housing being located adjacent each other and together defining an upper liquid outlet opening of the inner housing,
wherein the gas outlet opening of the outer housing is located radially inside the upper rim of the inner housing, and
wherein the upper liquid outlet opening of the inner housing is connected to the liquid outlet opening of the outer housing via the intermediate volume.

Thus, the present invention is based on the insight of having a design/construction of the centrifugal separator that provides an optimized flow path for the gas through the separator, with the goal of not losing pressure or flow speed and at the same time provide efficient separation of liquid from the wet gas. The inventive design of the separator provides a flow direction to the gas from the inlet orifice of the inner housing directly towards the gas outlet opening located at the top of the outer housing, i.e. the gas is given a flow direction circulating upwards from the inlet orifice of the inner housing directly towards the gas outlet opening located at the top of the outer housing.

According to various embodiment of the invention, an elevated pressure of the pressurized gas and the flow speed of the gas will force the liquid outwards to the inner surface of the inner housing wherein the liquid will start to accumulate and part of the liquid will run downwards towards the lower liquid opening of the inner housing and part of the liquid will follow the flow of gas upwards towards the upper liquid opening of the inner housing.

According to various embodiments of the invention, the inner surface of the top section of the outer housing comprises an annular ridge protruding downwards in relation to neighbouring portions of said inner surface of the top section of the outer housing, the annular ridge of the outer housing and the upper rim of the inner housing being located adjacent each other and together defining the upper liquid outlet opening of the inner housing. Thereby a more efficient separation of the liquid from the wet gas is provided.

According to various embodiments of the invention, a joint transverse centre axis of the inlet orifice of the inner housing and the inlet opening of the centrifugal separator, is arranged radially offset an axial centre axis of the inner housing. Thereby the wet gas enters the inner housing in a tangential direction strengthening the circulating flow and thereby a more efficient separation of the liquid from the wet gas is provided.

According to various embodiments of the invention, the lower liquid outlet opening of the inner housing is connected to the liquid outlet opening of the outer housing via the intermediate volume. Thereby, all liquid separated from the wet gas will leave the centrifugal separator via the liquid outlet opening of the outer housing. The separated liquid located in the intermediate volume is discharged from the liquid outlet opening of the outer housing by means of the pressure of the pressurized gas and by gravity.

According to various embodiments of the invention, wherein the inner housing has an annular main wall section comprising the inlet orifice, and a tapering bottom wall section comprising the lower liquid outlet opening. The annular main wall section of the inner housing is configured to generate an as low as possible flow resistance to the flow of pressurized gas, i.e. comprising no sharp edges/corners. The tapering bottom wall section of the inner housing is configured to accumulate the separated liquid in the inner housing in order to obtain a distinct flow of liquid out through the lower liquid outlet opening of the inner housing.

According to various embodiments of the invention, the inlet orifice of the inner housing is located at the lower end of the main wall section. A local elevated pressure is formed at the tapering bottom wall section just below the inlet orifice and the gas is given a more distinct flow direction circulating upwards from the inlet orifice of the inner housing.

According to various embodiments of the invention, the main wall section of the inner housing has a constant cross sectional area along the axial direction, or has an increasing cross sectional area in the upward direction. Thereby the gas is given a more distinct flow direction circulating upwards from the inlet orifice of the inner housing.

According to various embodiments of the invention, the main wall section of the inner housing has a circular cross section, or an oval cross section, seen from above. This provides the lowest possible flow resistance for the gas.

According to various embodiments of the invention, the outer housing has a main wall section comprising the inlet opening of the centrifugal separator, and a tapering bottom wall section comprising the liquid outlet. The tapering bottom wall section of the outer housing is configured to accumulate the separated liquid in the outer housing in order to obtain a distinct flow of liquid out through the lower liquid outlet opening of the outer housing.

According to various embodiments of the invention, the outer housing and the inner housing are coaxial. Thereby the flow and pressure characteristics in the intermediate volume are balanced in the circumferential direction of the centrifugal separator.

According to various embodiments of the invention, the upper rim of the inner housing is located radially outside the apex of the annular ridge of the outer housing. Thereby, a stagnation zone is generated by the annular ridge dividing the flow of gas from the flow of liquid in an efficient manner and obtaining a high separation capacity also at high flow speed of the gas.

According to various embodiments of the invention, the upper rim of the inner housing is located radially outside the annular ridge of the outer housing. Thereby, a stagnation zone is generated at the annular ridge dividing the flow of gas from the flow of liquid in an efficient manner and obtaining a high separation capacity also at high flow speed of the gas.

According to various embodiments of the invention, the upper rim of the inner housing is located at the same level or above the level of the apex of the annular ridge of the outer housing. Thereby a more efficient separation of liquid from the gas is provided.

According to various embodiments of the invention, wherein the cross sectional area of the gas outlet opening of the outer housing is greater than the cross sectional area of the lower liquid outlet opening of the inner housing. Thereby, the action of guiding the flow of gas upwards in the inner housing is enhanced.

Further advantages with and features of the invention will be apparent from the other dependent claims as well as from the following detailed description of preferred embodiments.

### BRIEF DESCRIPTION OF THE DRAWINGS

A more complete understanding of the abovementioned and other features and advantages of the present invention will be apparent from the following detailed description of preferred embodiments in conjunction with the appended drawings, wherein:

FIG. 1 is a schematic cross sectional side view of an inventive centrifugal separator,

FIG. 2 is a schematic cross sectional view from above of an inventive centrifugal separator,

FIG. 3 is a schematic cross sectional view from above of an inventive centrifugal separator,

FIG. 4 is a schematic cross sectional side view of an inventive centrifugal separator, and

FIG. 5 is a schematic cross sectional side view of an inventive centrifugal separator.

### DETAILED DESCRIPTION OF PREFERRED EMBODIMENTS OF THE INVENTION

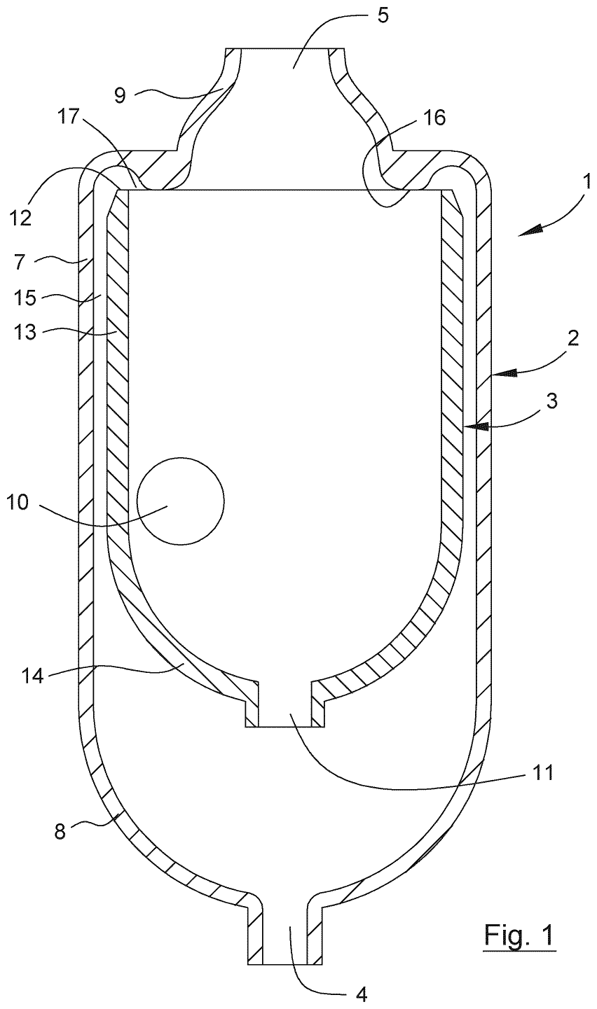

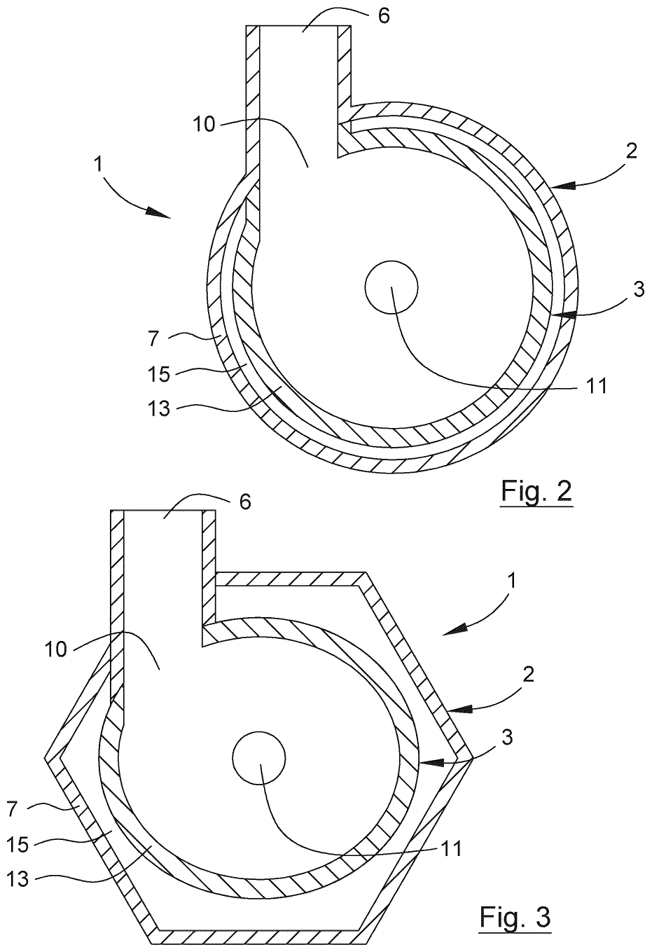

Reference is initially made to FIGS. 1-3 disclosing various embodiments of an inventive centrifugal separator, generally designated 1, configured for separating a liquid from a wet gas, including pressurized gas. Thus, the wet gas is supplied to the separator 1 whereby dry gas and liquid are discharged from the separator 1 separated from each other.

The gas, including pressurized gas, is for instance constituted by a pressure fluid of a pneumatically operated device. The pressure fluid is configured to perform duty/work, such as displace an element/component. The pneumatically operated device may be constituted by a combustion engine assembly or a pneumatic machine having pneumatically driven/operated components/tools. The pressure fluid (i.e. the gas, including pressurized gas) flows through the inventive centrifugal separator and to the pneumatically driven component/tool, such as an actuator configured for displacing a gas exchange valve of a camshaft free piston engine, via a pressure fluid circuit. Thus, the present invention is preferably intended to be used in a pressure fluid system comprising a pressure fluid circuit, wherein the pressure fluid circuit comprises a gas compressor for increasing the pressure of the gas, the inventive centrifugal separator 1 and a tool, connected in series. The gas compressor generates heat during operation and this generation of heat is reduced by having a considerable amount of lubrication liquid in the gas (i.e. a mist), however the tool cannot operate optimally if the pressurized wet gas comprises too much liquid. Other applications are conceivable, and the present invention is not limited to be used together with the described applications. The pressure level of the gas may for instance be as high as 8-30 bar.

The centrifugal separator 1 comprises an outer housing 2, and an annular inner housing 3 located within the outer housing 2. The annular inner housing 3 and the outer housing 2 together generate an intermediate chamber delimited by the inner housing 3 and the outer housing 2. According to various embodiments the outer housing 2 and the inner housing 3 are coaxial.

According to various embodiments, the inner diameter of the outer housing 2 is equal to or more than 40 millimetres and equal to or less than 80 millimetres. Preferably equal to or more than 50 millimetres and equal to or less than 70 millimetres.

The outer housing 2 comprises a liquid outlet opening 4 located at a bottom of the outer housing 2, a gas outlet opening 5 located at a top of the outer housing 2, and the centrifugal separator 1 comprises an inlet opening 6 for wet gas and/or wet pressurized gas, i.e. a mixture of gas and liquid. The inlet opening 6 of the centrifugal separator 1 is located between the liquid outlet opening 4 and the gas outlet opening 5 of the outer housing 2, seen in the axial/vertical direction of the separator 1. Said openings are provided with connection means in order to connect pipes/conduits to the separator 1. Preferably said connection means are threaded connection means. According to various embodiments the inlet opening 6 has an inner diameter of approx. 15 millimetres. According to various embodiments the liquid outlet opening 4 has an inner diameter of approx. 6 millimetres. According to various embodiments the gas outlet opening 5 has an inlet diameter of approx. 15-23 millimetres.

According to various embodiments the liquid outlet opening 4 and/or the gas outlet opening 5 is located at an axial centre axis of the outer housing 2. The outer housing 2 is preferably divided into a top part and a bottom part which are connected to each other in order to be able to insert the inner housing 3. The outer housing 2 has a main wall section 7 comprising the inlet opening 6, and a tapering bottom wall section 8 comprising the liquid outlet opening 4, and a top section 9 comprising the gas outlet opening 5. The main wall section 7 extends between the bottom wall section 8 and the top section 9. The tapering of the bottom wall section 8 entails that the cross sectional area of the outer housing 2 is decreasing in the downward direction, from the main wall section 7 to the liquid outlet opening 4. Thus, the bottom wall section 8 is funnel-shaped having straight or curved sides.

According to various embodiments, the cross section of the main wall section 7 of the outer housing 2 has an annular basic shape, i.e. circular, oval, etc. Preferably the cross sectional area of the main wall section 7 is constant along the axial direction. According to various embodiments, the main wall section 7 of the outer housing 2 has at least an axial section that has polygonal basic shape, i.e. cross section, such as six or eight sides in order to be able grip/fixate the separator 1 using a wrench or the like.

The inner housing 3 comprises an inlet orifice 10, wherein the inlet opening 6 of the centrifugal separator 1 extends to said inlet orifice 10 of the inner housing 3, a lower liquid outlet opening 11 located at a bottom of the inner housing 3, and an annular upper rim 12. The inlet orifice 10 of the inner housing 3 is located between the liquid outlet opening 11 and the upper rim 12, seen in the axial/vertical direction of the separator 1. The inner housing 3 has an annular main wall section 13 comprising the inlet orifice 10, and a tapering bottom wall section 14 comprising the liquid outlet opening 11. The upper rim 12 terminates the main wall section 13 of the inner housing 3, and the main wall section 13 extends between the bottom wall section 14 and the upper rim 12. The tapering of the bottom wall section 14 entails that the cross sectional area of the inner housing 3 is decreasing in the downward direction, from the main wall section 13 to the liquid outlet opening 11. Thus, the bottom wall section 14 is funnel-shaped having straight or curved sides. Thereby there will be a local elevated pressure at the bottom wall section 14 and the wet gas flow will be directed upwards in the inner housing. The main wall section 13 preferably has a decreasing thickness adjacent the upper rim 12, i.e. making the upper rim 12 thin.

The inner housing 3 being annular, means that the cross section of the main wall section 13 and the upper rim 12 has annular basic shape, i.e. circular, oval, etc., in order to provide as low flow resistance as possible to the gas. The inlet orifice 10 of the inner housing 3 is preferably located at the lower end of the main wall section 13, i.e. adjacent the bottom wall section 14. A joint transverse centre axis of the inlet orifice 10 of the inner housing 3 and the inlet opening 6 of the outer housing 2, is arranged radially offset the axial centre axis of the inner housing 3, in order to obtain a spiral-shape gas flow.

The basic shape of the cross section of the main wall section 7 of the outer housing 2 is preferably equal to the basic shape of the cross section of the main wall section 13 of the inner housing 3. A circumferential gap 15 is formed between the main wall section 7 of the outer housing 2 and the main wall section 13 of the inner housing 3, wherein the gap 15 adjacent the upper rim 12 has a width in the radial direction that is equal to or more than 0.5 millimetres and equal to or less than 3 millimetres. The width of the gap 15 may differ in the circumferential direction and/or in the axial direction.

According to various embodiments, the lower liquid outlet opening 11 of the inner housing 3 is connected to the liquid outlet opening 4 of the outer housing 2 via the intermediate volume/chamber. In other embodiments/alternatives the liquid outlet opening 11 of the inner housing 3 is connected to the outside of the outer housing 2 via a conduit separated from the liquid outlet opening 4 of the outer housing 2.

According to the invention, an inner surface of a top section 9 of the outer housing 2 and the upper rim 12 of the inner housing 3 are located adjacent each other and together define an upper liquid outlet opening 17 of the inner housing 3. The upper liquid outlet opening 17 of the inner housing 3 is the opening of the circumferential gap 15. The distance between the inner surface of the top section 9 of the outer housing 2 and the upper rim 12 of the inner housing 3 is equal to or more than 0.5 millimetres and equal to or less than 3 millimetres, preferably equal to or less than 2 millimetres. The width in the radial direction of the upper liquid outlet opening 17 of the inner housing 3 may differ in the circumferential direction, but is preferably constant. The upper liquid outlet opening 17 of the inner housing 3 is connected to the liquid outlet opening 4 of the outer housing 2 via the intermediate volume, i.e. via the circumferential gap 15.

According to various embodiments, the inner surface of the top section 9 of the outer housing 2 comprises an annular ridge 16 protruding downwards in relation to neighbouring portions of said inner surface of the top section 9 of the outer housing 2. A radially inner side of the annular ridge 16 is preferably placed adjacent the gas outlet opening 5 of the outer housing 2.

The annular ridge 16 of the top section 9 of the outer housing 2 and the upper rim 12 of the inner housing 3 are located adjacent each other and together define the upper liquid outlet opening 17 of the inner housing 3. The upper liquid outlet opening 17 of the inner housing 3 is the opening of the circumferential gap 15. The distance between the annular ridge 16 of the outer housing 2 and the upper rim 12 of the inner housing 3 is equal to or more than 0.5 millimetres and equal to or less than 3 millimetres, preferably equal to or less than 2 millimetres. The width in the radial direction of the upper liquid outlet opening 17 of the inner housing 3 may differ in the circumferential direction, but is preferably constant. The upper liquid outlet opening 17 of the inner housing 3 is connected to the liquid outlet opening 4 of the outer housing 2 via the intermediate volume, i.e. via the circumferential gap 15.

The configuration of the main wall section 13 and the upper liquid outlet opening 17 of the inner housing 3 entail that the liquid will follow the gas flow upwards along the inner surface of the inner housing 3, and the liquid will thereafter enter the upper liquid outlet opening 17 and will have precedence/block the majority of the gas from entering the upper liquid outlet opening 17. The majority of the gas will leave the inner housing 3 and enter the gas outlet opening 5 of the outer housing 2. The gas outlet opening 5 of the outer housing 2 is located radially inside the upper rim of the inner housing. When the annular ridge is present, the gas outlet opening 5 of the outer housing is located radially inside the annular ridge 16 of the outer housing 2. Some gas will follow the liquid through the circumferential gap 15 and thereafter reenter into the inner housing 3 through the lower liquid outlet opening 11 of the inner housing 3. At the centre of the inner housing 3 there is locally lower pressure entailing that the gas located in the intermediate volume between the outer housing 2 and the inner housing 3 will be sucked into inner housing 3 through the lower liquid outlet opening 11 of the inner housing 3.

Thus, the configuration of the annular ridge 16 of the outer housing 2 together with the upper rim 12 of the inner housing 3 secures that the liquid flowing upwards along the inner surface of the inner housing 3 does not re-enter into the pressurized gas flow leaving the inner housing 3.

According to various embodiments, the annular ridge 16 is located in a radial/horizontal plane, and the upper rim 12 of the inner housing 3 is located in a radial/horizontal plane.

According to various embodiments, the upper rim 12 of the inner housing 3 is located radially outside the apex of the annular ridge 16 of the outer housing 2. Thereby, the separating effect of the liquid flow entering the upper liquid outlet opening 17 of the inner housing 3 from the gas flow entering the gas outlet opening 5 of the outer housing 2 is enhanced. Alternatively, the rim 12 may be located opposite the apex of the annular ridge 16 and likewise have distinct separation of liquid flow and gas flow. The cross sectional area of the gas outlet opening 5 of the outer housing 2 is greater than the cross sectional area of the lower liquid outlet opening 11 of the inner housing 3, in order to direct the gas flow upwards in the separator 1.

According to various embodiments, the upper rim 12 of the inner housing 3 is located radially outside the annular ridge 16 of the outer housing 2. Thereby, no liquid flowing/running upwards along the inner surface of the inner housing 3 may re-enter the gas flow leaving the separator 1. According to various embodiments, the upper rim 12 of the inner housing 3 is located at the same level or above the level of the apex of the annular ridge 16 of the outer housing 2.

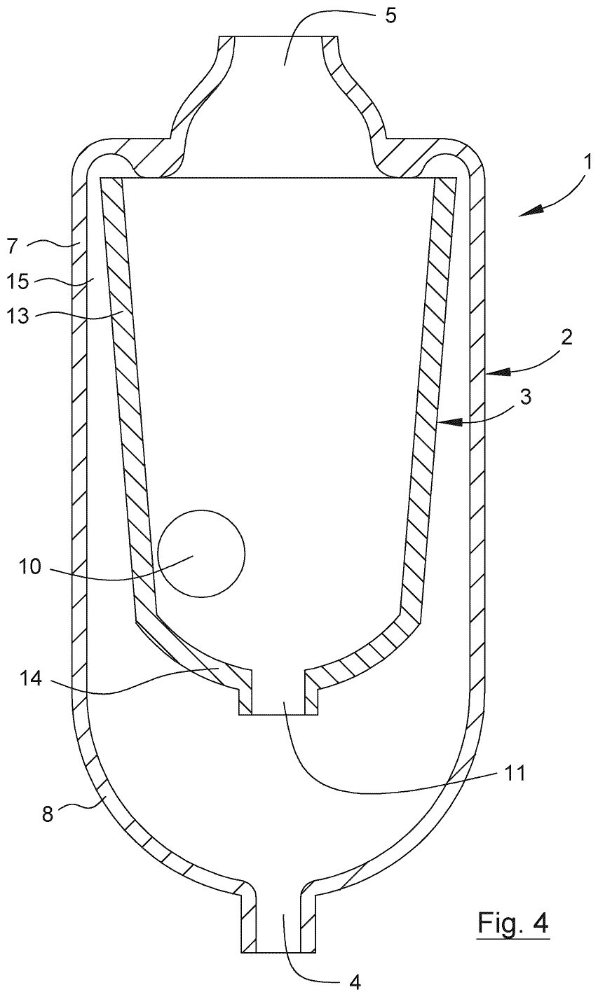

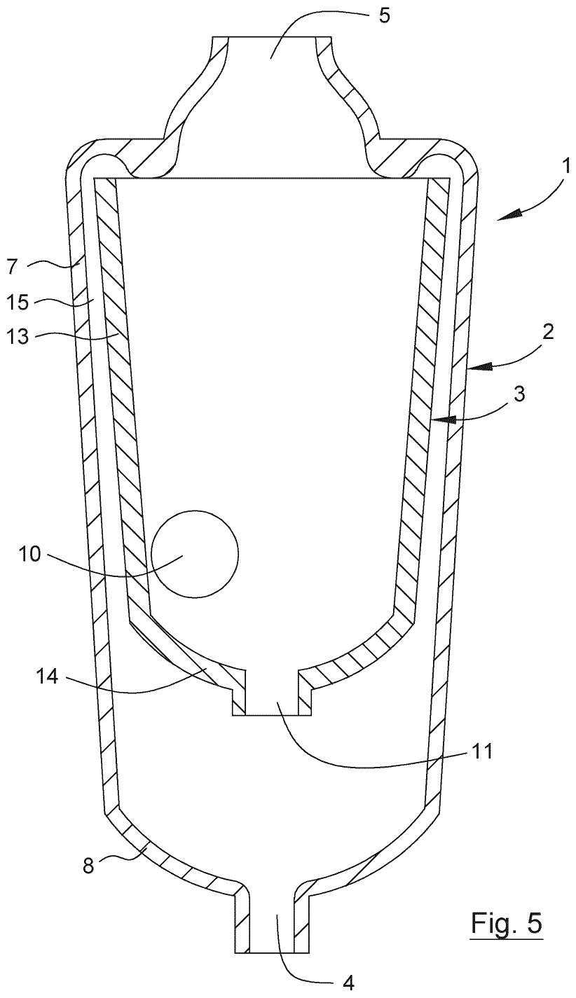

Reference is also made to FIGS. 4 and 5, disclosing various embodiments/alternatives that are combinable with the embodiments/alternatives described above.

The main wall section 13 of the inner housing 3, instead of having a constant cross sectional area along the axial direction, has an increasing cross sectional area in the upward direction from the bottom wall section 14 towards the upper rim 12. The upper portion of the main wall section 13 of the inner housing 3, i.e. adjacent the upper rim 12, may have a constant cross sectional area. The cross sectional area of the main wall section 7 of the outer housing 2 may be constant along the axial direction or may be increasing in the upward direction from the bottom wall section 8 to the top section 9.

### Feasible Modifications of the Invention

The invention is not limited to only the abovementioned and embodiments shown in the drawings, which only have an illustrating and exemplifying purpose. This patent application is intended to cover all modifications and variants of the preferred embodiments described herein, and the present invention is consequently defined by the wording of the enclosed claims and the equipment can thus be modified in all conceivable ways within the framework of the enclosed claims.

It should also be pointed out that all information about/concerning terms such as above, below, upper, lower, etc. shall be interpreted/read with the equipment oriented in accordance with the figures, with the drawings oriented in such a way that the reference numbers can be read in a correct manner. Consequently, such terms only indicate relative relationships in the shown embodiments, which relationships can be changed if the equipment according to the invention is provided with another construction/design.

It shall also be pointed out that even thus it is not explicitly stated that features from a specific embodiment may be combined with features from another embodiment, the combination shall be considered obvious, if the combination is possible.

1. Centrifugal separator (1) for separating liquid from a wet gas, wherein the separator (1) comprises:
an outer housing (2) comprising:
a liquid outlet opening (4) located at a bottom of the outer housing (2),
a gas outlet opening (5) located at a top of the outer housing (2), and wherein the centrifugal separator (1) comprises an inlet opening (6) for wet gas, located between the liquid outlet opening (4) and the gas outlet opening (5) of the outer housing (2), characterized in that the separator (1) further comprises:
an annular inner housing (3) located within the outer housing (2) forming an intermediate volume delimited by the inner housing (3) and the outer housing (2), wherein the inlet opening (6) of the centrifugal separator (1) extends to the inner housing and the inner housing (3) comprises:
an inlet orifice (10) of the inlet opening (6),
a lower liquid outlet opening (11) located at a bottom of the inner housing (3), and
an annular upper rim (12),
wherein an inner surface of a top section (9) of the outer housing (2) and the upper rim (12) of the inner housing (3) being located adjacent each other and together defining an upper liquid outlet opening (17) of the inner housing (3),
wherein the gas outlet opening (5) of the outer housing (2) is located radially inside the upper rim (12) of the inner housing (3), and
wherein the upper liquid outlet opening (17) of the inner housing (3) is connected to the liquid outlet opening (4) of the outer housing (2) via the intermediate volume.

2. The centrifugal separator (1) according to claim 1, wherein the inner surface of the top section (9) of the outer housing (2) comprises an annular ridge (16) protruding downwards in relation to neighbouring portions of said inner surface of the top section of the outer housing (2), the annular ridge (16) of the outer housing (2) and the upper rim (12) of the inner housing (3) being located adjacent each other and together defining the upper liquid outlet opening (17) of the inner housing (3).

3. The centrifugal separator (1) according to claim 1, wherein a joint transverse centre axis of the inlet orifice (10) of the inner housing (3) and the inlet opening (6) of the centrifugal separator (1), is arranged radially offset an axial centre axis of the inner housing (3).

4. The centrifugal separator (1) according to claim 1, wherein the lower liquid outlet opening (11) of the inner housing (3) is connected to the liquid outlet opening (4) of the outer housing (2) via the intermediate volume.

5. The centrifugal separator (1) according to claim 1, wherein the inner housing (3) has an annular main wall section (13) comprising the inlet orifice (10), and a tapering bottom wall section (14) comprising the lower liquid outlet opening (11).

6. The centrifugal separator (1) according to claim 5, wherein the inlet orifice (10) of the inner housing (3) is located at the lower end of the main wall section (13).

7. The centrifugal separator (1) according to claim 5, wherein the main wall section (13) of the inner housing (3) has a constant cross sectional area along the axial direction, or has an increasing cross sectional area in the upward direction.

8. The centrifugal separator (1) according to claim 5, wherein the main wall section (13) of the inner housing (3) has a circular cross section, or an oval cross section, seen from above.

9. The centrifugal separator (1) according to claim 1, wherein the outer housing (2) has a main wall section (7) comprising the inlet opening (6) of the centrifugal separator (1), and a tapering bottom wall section (8) comprising the liquid outlet opening (4).

10. The centrifugal separator (1) according to claim 1, wherein the outer housing (2) and the inner housing (3) are coaxial.

11. The centrifugal separator (1) according to claim 2, wherein the upper rim (12) of the inner housing (3) is located radially outside the apex of the annular ridge (16) of the outer housing (2).

12. The centrifugal separator (1) according to claim 2, wherein the upper rim (12) of the inner housing (3) is located radially outside the annular ridge (16) of the outer housing (2).

13. The centrifugal separator (1) according to claim 11, wherein the upper rim (12) of the inner housing (3) is located at the same level or above the level of the apex of the annular ridge (16) of the outer housing (2).

14. The centrifugal separator (1) according to claim 1, wherein the cross sectional area of the gas outlet opening (5) of the outer housing (2) is greater than the cross sectional area of the lower liquid outlet opening (11) of the inner housing (3).
